(19) United States
(12) Patent Application Publication
(10) Pub. No.: US 2025/0289000 A1
(43) Pub. Date: Sep. 18, 2025

(54) CONTINUOUS FEED CONE CRUSHER PROTECTION SYSTEM AND METHOD

(71) Applicant: MCCLOSKEY INTERNATIONAL LIMITED, Keene (CA)

(72) Inventors: Andrzej Krol, Oshawa (CA); Danny McElchar, Greendale, WI (US)

(73) Assignee: MCCLOSKEY INTERNATIONAL LIMITED, Keene (CA)

(21) Appl. No.: 18/606,574

(22) Filed: Mar. 15, 2024

(51) Int. Cl. B02C 2/00; B02C 23/08; B02C 25/00

(52) U.S. Cl. CPC B02C 2/007; B02C 23/08; B02C 25/00

(57) ABSTRACT

A crushing machine that includes a crusher device fed by a feed conveyor for processing a feed of aggregate material. A detector is positioned along the feed conveyor to detect the presence of an undesirable material, such as a portion of metallic material. Upon detection of the undesirable material, a diverter is moved from a first mode to a second mode to divert the feed of material away from the crusher device. Once the detected undesirable material is no longer present in the feed of material, the diverter is returned to the first mode after a delay to direct the feed of aggregate material back to the crusher device. The operating speed of the feed conveyor is not adjusted during the movement of the diverter. The diverted feed of aggregate material is directed to a discharge chute located away from the infeed end of the crusher device.

### BACKGROUND

The present disclosure generally relates to a system and method for protecting a crusher device from damage caused by undesirable and uncrushable material in a feed of aggregate. More specifically, the present disclosure relates to a system and method that detects the presence of an undesirable metallic material in the continuous feed of aggregate and diverts the feed of aggregate material away from the crusher device until the undesirable material has been cleared from the continuous feed of material.

Mobile crushing machines are often used in a quarry or another environment to crush stone, rubble and other material this is being cleared from a site into smaller material that can then be either further processed or used in other applications. In many mobile crushing machines, the machine includes a crusher device that receives a continuous feed of aggregate material from a feed conveyor. The crusher device receives the continuous feed of aggregate material and operates to reduce the size of the individual pieces of aggregate material in the feed. Typically, the crusher device can be a cone crusher or a jaw crusher that reduces the size of the aggregate particles by compressing the aggregate particles between a pair of durable crushing surfaces.

In the clearance of material from a site, it is often the case that loose or attached metal reinforcing rods, metal beams or other larger metal fragments can find their way into the continuous feed of aggregate material. If and when this undesirable metallic material is fed into the crusher device, the undesirable metallic material can do damage to the crusher or cause a jam that needs to be cleared by the operator, which typically requires a complete shutdown of the mobile crushing machine.

In many past mobile crushing machines, one or more metal detectors is positioned somewhere along the feed conveyor to detect the presence of a metallic material in the feed of the aggregate material. Upon the detection of the metallic material, the feed conveyor is completely stopped, and the metallic material is removed from the feed of aggregate before the metallic material reaches the crusher device.

Although the prior art systems that detect the presence of the metallic material in the feed of the aggregate material can prevent the metallic material from reaching the crusher device, the inventors have recognized the problems with completely shutting down the feed conveyor and removing the undesirable material by either physically removing the material or moving the discharge end of the feed conveyor away from the infeed location of the crusher device. Such systems reduce the operating efficiency of the entire mobile crushing system and reduces the throughput of the crushing system. Thus, the inventors have developed a system and method that can prevent undesirable material from reaching the crusher device without stopping the operation of the feed conveyor.

### SUMMARY

The present disclosure relates to a crushing machine for processing a continuous feed of an aggregate material. The crushing machine includes a system and method for protecting a crusher device from damage caused by undesirable and uncrushable material in a feed of aggregate. More specifically, the present disclosure relates to a system and method that detects the presence of an undesirable metallic material in the continuous feed of aggregate and diverts the feed of aggregate material away from the crusher device until the undesirable material has been cleared from the continuous feed of material.

The crushing machine in accordance with one embodiment of the present disclosure includes a feed conveyor that extends between an infeed end and a discharge end. The feed conveyor is operable to receive a feed of aggregate at the infeed end and move the feed of aggregate to the discharge end, thereby creating a continuous feed of the aggregate material. A crusher device of the crushing machine is positioned below the discharge end of the feed conveyor. The crusher device is operable to reduce the size of the aggregate material. In one exemplary embodiment, the crusher device is a cone crusher that receive the continuous feed of aggregate material at an upper, open entrance.

The crushing machine further includes a diverter that is positioned at the discharge end of the feed conveyor. The diverter receives the continuous feed of aggregate material from the feed conveyor. The diverter is movable between a first mode that directs the feed of material to the crusher device and a second mode that directs the feed of aggregate material away from the crusher device to a bypass location. The diverter can be a diverter chute that is movable between first and second positions to selectively divert the feed of aggregate material away from the crusher device while the feed conveyor continues to operate at a normal operating speed.

In accordance with an exemplary embodiment, the crushing machine includes a detector that is positioned relative to the feed conveyor such that the detector can detect the presence of an undesirable material in the feed of the aggregate material. In one embodiment of the disclosure, the detector is a metal detector positioned above the feed conveyor and is operable to detect the presence of a metallic material in the continuous feed of material.

The crushing machine further includes either a separate or integrated control unit that is operable to move the diverter between the first and second modes. The control unit moves the diverter to the second mode upon detection of the undesirable material to prevent the undesirable material from entering into the crusher device.

In accordance with one embodiment of the present disclosure, the crushing machine includes a bypass chute that is positioned to receive the feed of aggregate from the feed conveyor when the diverter chute is in the second position. The bypass chute includes a discharge end that is spaced away from the crusher device such that the bypass chute diverts the feed of material away from the crusher device.

In one embodiment of the present disclosure, the crushing machine includes a chute actuator that is operable to move the diverter chute between the first and second positions. The control unit is able to control the operation of the chute actuator to control the movement of the diverter chute.

In another contemplated embodiment, a system is provided for protecting a crusher device from receiving undesirable material included in a feed of aggregate material being fed to the crusher device by a feed conveyor that includes a moving conveyor belt extending from an infeed end to a discharge end.

The system further includes a diverter chute that is positioned at the discharge end of the feed conveyor. The diverter chute receives the continuous feed of aggregate material from the feed conveyor. The diverter chute is movable between a first position that directs the feed of material to the crusher device and a second position that directs the feed of aggregate material away from the crusher device to a bypass location.

In accordance with an exemplary embodiment, the system includes a detector that is positioned relative to the feed conveyor such that the detector can detect the presence of an undesirable material in the feed of the aggregate material. In one embodiment of the disclosure, the detector is a metal detector positioned above the feed conveyor and is operable to detect the presence of a metallic material in the continuous feed of material.

The system further includes either a separate or integrated control unit that is operable to move the diverter between the first and second modes or positions. The control unit moves the diverter to the second position upon detection of the undesirable material to prevent the undesirable material from entering into the crusher device.

In accordance with another contemplated embodiment, a method is provided for protecting a crusher device from receiving undesirable material included in a feed of aggregate material being fed to the crushing device by a feed conveyor that includes a moving conveyor belt extending from an infeed end to a discharge end. The method positions a diverter at the discharge end of the feed conveyor. The diverter is movable between a first mode or position to direct the feed of aggregate material to the crusher device and a second mode or position to direct the feed of aggregate material to a bypass location. The method detects the presence of the undesirable material in the feed of aggregate material. When the undesirable material is detected, the diverter is moved from the first mode or position to the second mode or position to prevent the undesirable material from reaching the crusher device.

During the movement of the diverter, the operating speed of the feed conveyor remains at the operating speed such that the operation of the feed conveyor is not affected by the movement of the diverter. The diverter is moved back to the first position to supply the feed of aggregate to the crusher device after the detector no longer senses the undesirable material and after a time delay to make sure that all of the undesirable material is diverted away from the crusher device.

In another contemplated embodiment, the method can include the step of detecting the level of material in the crusher device and diverting the feed of aggregate material away from the crusher device when the detected level exceeds a threshold. In this manner, material can be diverted away from the crusher upon a jamb or feed levels too high for the crusher device to handle.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a side view of a mobile crushing device that includes the system in accordance with the present disclosure;

FIG. 2 is a magnified view of the diverter chute positioned at the discharge end of the feed conveyor of the mobile crushing device;

FIG. 3A is an end view showing the diverter chute in a first position to direct the feed of aggregate material to the crusher device;

FIG. 3B is an end view showing the diverter chute in a second position to direct the feed of aggregate material away from the crusher device;

FIG. 4 is an end view showing the diversion of the feed of aggregate material to a bypass chute;

FIG. 5 is a schematic illustration of the operating and control components for controlling the movement of the diverter chute;

FIG. 6 is a flow chart of one method of controlling the position and movement of the diverter chute;

FIG. 7 is an end view showing a first alternate embodiment of a diverter in a first mode to direct the feed of aggregate material to the crusher device;

FIG. 8 is an end view of the first alternate embodiment of the diverter in a second mode to direct the feed of aggregate material away from the crusher device;

FIG. 9 is an end view showing a second alternate embodiment of a diverter in a first mode to direct the feed of aggregate material to the crusher device;

FIG. 10 is an end view showing the second alternate embodiment of a diverter in a second mode to direct the feed of aggregate material away from the crusher device;

FIG. 11 is an end view showing a third alternate embodiment of a diverter in a first mode to direct the feed of aggregate material to the crusher device; and

FIG. 12 is an end view showing the third alternate embodiment of a diverter in a second mode to direct the feed of aggregate material away from the crusher device.

### DETAILED DESCRIPTION

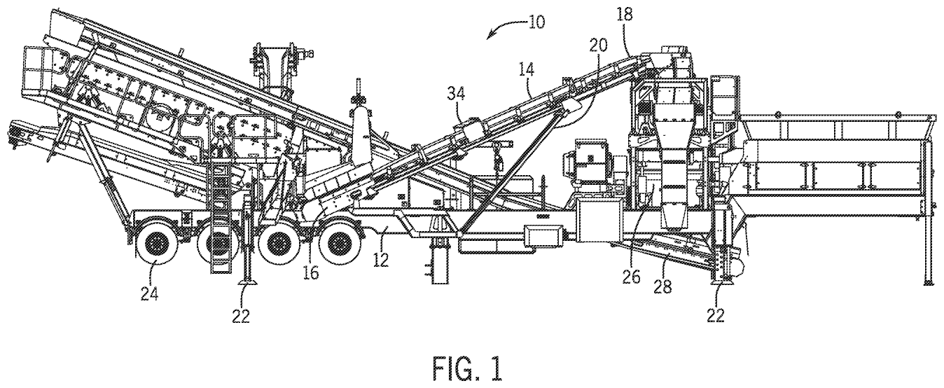

FIG. 1 illustrates a mobile crushing machine 10 that is operable to crush stone, aggregate and other similar types of material. The mobile crushing machine 10 shown in FIG. 1 is mounted on a trailer 12 that allows the entire mobile crushing machine 10 to be moved to desired locations for crushing material at the location. In the embodiment shown in FIG. 1, the mobile crushing machine 10 includes a feed conveyor 14 that receives a feed of aggregate material that is going to be crushed and reduced in size by the mobile crushing machine 10. The feed conveyor 14 extends between an infeed end 16 and a discharge end 18. The feed conveyor 14 includes a moving conveyor belt that moves material from the infeed end 16 to the discharge end 18. In the embodiment shown in FIG. 1, the feed conveyor 14 is inclined from the infeed end 16 to the discharge end 18 and is supported in this inclined position by one or more support struts 20. In other alternate, contemplated embodiments, the feed conveyor 14 could be horizontal or could be replaced with a screening device to feed material for crushing.

In the operating position shown in FIG. 1, the trailer 12 is supported by a series of ground engaging support struts 22 such that the trailer wheels 24 are elevated above the ground surface. In typical applications, the mobile crushing machine 10 is taken to a desired location and the support struts 22 are extended to hold the mobile crushing machine 10 in the desired location during what could be an extended operating period. Although a trailer mounted mobile crushing machine is shown in the Figures, other types of crushing machines are contemplated as being within the scope of the present disclosure, such as smaller and lighter track plants or other similar configurations of a crushing machine.

The mobile crushing machine 10 further includes a crusher device 26 that has an open entrance opening to receive the continuous feed of aggregate material from the feed conveyor 14. In the embodiment shown in FIG. 1, the crusher device 26 is a cone crusher that receives the continuous feed of aggregate material at the open entrance opening that is positioned directly below the discharge end 18 of the feed conveyor. The cone crusher that forms the crusher device 26 operates to reduce the size of the particles of aggregate material between an eccentrically moving mantle and a stationary bowl assembly. Both the mantle and the bowl assembly include wear components formed from a hard material such that the aggregate material can be crushed during the operating movement of the mantle within the stationary bowl assembly. As indicated previously, it is desirable to prevent undesirable material, referred to as tramp material, from entering into the crushing cone and causing damage to the operating components of the crusher device. Although a cone crusher is shown and described as being the crusher device, various other types of crusher devices that can receive a continuous feed of material are contemplated as being within the scope of the present disclosure.

Referring back to FIG. 1, the lower, discharge end of the crusher device 26 is positioned above a discharge conveyor 28 such that the crusher device 26 feeds the crushed material onto the discharge conveyor 28. The discharge conveyor 28 is separately operable to move the crushed material along the length of the discharge conveyor 28 for further use and processing. The orientation and length of the discharge conveyor 28 can be modified by adjusting other components of the mobile crushing machine 10. However, the material that has passed through the crusher device 26 will have aggregate particles that have a smaller size than the size of the aggregate particle that are included in the continuous feed of aggregate material moved along the length of the feed conveyor 14.

Although the crusher device 26 is shown and described in the drawings as being a cone crusher, it should be understood that various other types of crusher devices could be utilized while operating within the scope of the present disclosure. As an illustrative example, the crusher device 26 could be a jaw crusher, gyratory crusher, hydraulic roll crusher or any other type of crusher device that is able to reduce the size of aggregate particles that are continuously fed to the crusher device as part of an aggregate feed of material.

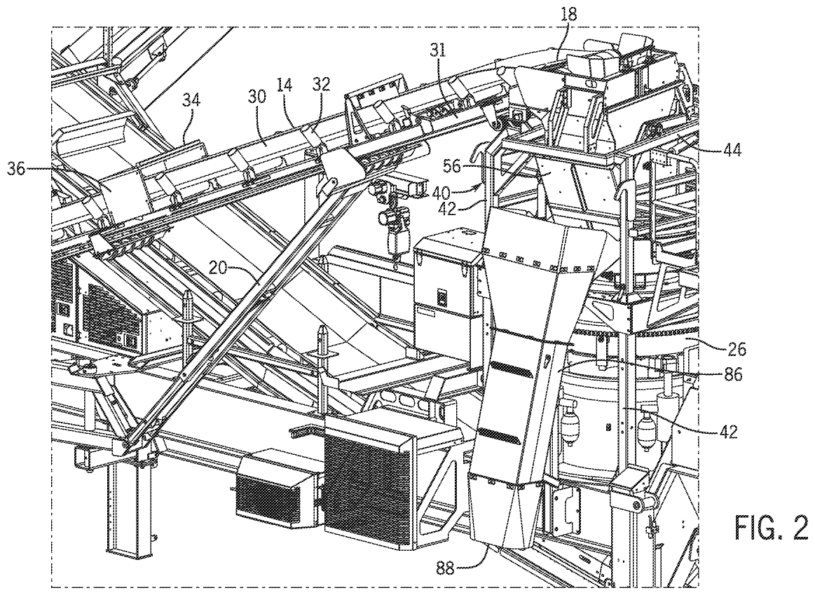

FIG. 2 is a magnified view of the feed conveyor 14 that directs the feed of aggregate material to the discharge end 18. The feed conveyor 14 includes a flexible conveyor belt 30 that has a generally V shape and moves along the conveyor frame 31 and is supported by a series of idler rollers 32. In accordance with the present disclosure, as the feed of aggregate material moves upward along the longitudinal length of the feed conveyor 14, the feed of aggregate material passes beneath a detector 34. The detector 34 shown in the embodiment of FIG. 2 is mounted within a mounting frame 36 such that the feed of aggregate material can pass beneath the detector 34. The detector 34 is configured such that the detector 34 can detect the presence of an undesirable material in the feed of aggregate material. In accordance with one exemplary embodiment of the present disclosure, the detector 34 is a metal detector that is operable to detect the presence of an undesirable metallic material in the feed of aggregate material moved along the length of the feed conveyor 14. The metal detector 34 is selected such that the sensitivity of the detector 34 can be adjusted by the operator to detect undesirable metallic material having a size sufficient to both be detected and not freely pass through the crusher device 26. Various different types of metal detectors can be used as the detector 34 as long as the metal detector is able to accurately detect the presence of a metallic material in the continuous feed of the aggregate material. In other contemplated embodiment, the undesirable material may not just be metallic material and the metal detector could be replaced with other types of detectors that are able to detect the undesirable material. As an example, the detector could be a camera or optical sensor that detects material having a size greater than a determined threshold. The sensed undesirable material could be formed of material other than metal yet could cause damage or blockage of the crusher device.

In the embodiment shown in FIGS. 1 and 2, the detector 34 is positioned a known distance from the discharge end 18 of the feed conveyor 14 that is sufficiently long such that a response action can be carried out to prevent the undesirable material from reaching the crusher device 26 when the detector 34 detects the presence of the undesirable material. As can be understood, positioning the detector 34 too close to the discharge end 18 would not allow the system and method of the present disclosure to react to the detected presence of the undesirable material to take a remedial action to prevent the undesired material from entering into the entrance opening of the crusher device 26.

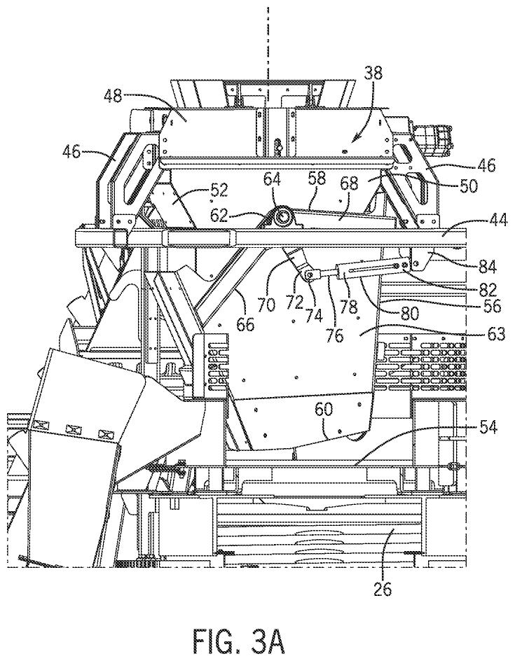

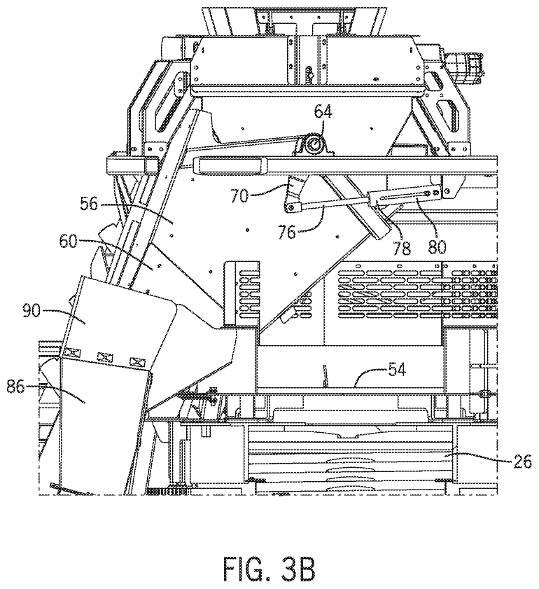

Referring now to FIG. 3A, the discharge end of the discharge conveyor directs the continuous feed of aggregate material into a top hopper 38 that is located at the top of a support frame 40 that extends around the entire crusher device 26, as best shown in FIG. 2. The support frame 40 includes a series of vertical legs 42 located along each side of the crusher device 26. The vertical legs 42 extend upward to support a horizontal frame portion 44. As shown in FIG. 3A, the horizontal frame portion 44 provides points of connection for a series of braces 46 that provide mounting support for the top hopper 38. The top hopper 38 includes an upper receiving end 48 that is connected to the top end of a reducing portion 50. The reducing portion 50 includes a pair of inwardly sloped side walls 52 that are designed to consolidate the continuous feed of the aggregate material for directing the continuous feed of material to the open upper entrance 54 of the crusher device 26.

In prior art mobile crushing systems, the continuous feed of aggregate material leaving the top hopper 38 is directed directly into the open upper entrance 54 of the crusher device 26. Thus, any undesirable, metallic material that is included in the continuous feed of aggregate material will be fed directly into the crusher device 26. In accordance with the present disclosure, a modified diverter is provided to collectively divert the continuous feed of aggregate material away from the open upper entrance 54 when undesirable metallic material is detected within the feed of aggregate material. The system and method of the present disclosure thus allows the feed of aggregate material to be selectively diverted away from the open upper entrance 54 of the crusher device 26 to prevent the undesired metallic material from entering into the crusher device 26 to thereby cause damage or jamming.

As illustrated in FIG. 3A, in accordance with the present disclosure, a first embodiment of a diverter to divert the feed of aggregate material from the crusher device 26 is shown as a diverter chute 56 that is included as part of the mobile crushing machine of the present disclosure. Although a diverter chute 56 is shown in this first, exemplary embodiment, other types of diverters will be described in the alternate embodiments described below. The diverter chute 56 includes an upper infeed end 58 and a lower discharge end 60. The diverter chute 56 includes a series of side walls 63 that direct the continuous feed of aggregate material from the infeed end 58 to the discharge end 60.

As shown in FIG. 3A, the diverter chute 56 is mounted and supported by the horizontal frame portion 44. Specifically, a pivot bracket 62 is mounted to the horizontal frame portion on both sides of the diverter chute 56. A pair of pivot pins 64 provides a pivoting connection between the diverter chute 56 and the pivot brackets 62 located on opposite sides of the diverter chute 56. The outer surface of the diverter chute 56 includes a pair of support rails 66 and 68. The support rails 66, 68 are in turn connected to a lever arm 70. The outer end 72 of the lever arm 70 is connected to an outer end 74 of a cylinder rod 76 that is included as part of a chute actuator 78. In the embodiment shown, the chute actuator 78 is a hydraulically actuated cylinder that is able to selectively extend and retract the cylinder rod 76 from the actuator body 80. The opposite end 82 of the cylinder body 80 is connected to a stationary bracket 84.

In the embodiment shown in FIG. 3A, the cylinder rod 76 is in a fully retracted position such that the diverter chute 56 is in a first mode of operation in which the diverter chute 56 is in a first position in which the feed of aggregate material is fed to the upper open entrance of the crusher device 26. In the embodiment shown in FIG. 3B, the chute actuator 78 is activated such that the cylinder rod 76 is fully extended from the body 80. During this movement, the entire diverter chute 56 moves away from the crusher device 26 through the pivoting movement of the lever arm 70 about the pivot pin 64. During this movement, the discharge end 60 of the diverter chute 56 is moved away from the open upper entrance 54 of the crusher device 26. In this second mode of operation, the diverter chute 56 is in a second, diverted position and the discharge chute 56 no longer directs the feed of aggregate material to the crusher device 26 and instead directs the feed of the aggregate material into a bypass chute 86.

As can best be seen in FIG. 2, the bypass chute 86 is mounted to an exterior portion of the support frame 40 and directs the feed of aggregate material away from the crusher device 26. The bypass chute 86 includes a discharge end 88 that is located away from the crusher device 26 and thus can divert the feed of aggregate material away from the crusher device 26 based upon the movement of the diverter chute 56.

Referring back to FIG. 3B, the bypass chute 86 includes an upper receiving end 90 that is sized to receive the discharge end 60 of the diverter chute 56 when the diverter chute is moved to the second position shown in FIG. 3B. In this second position, the diverter chute 56 directs the continuous feed of aggregate material away from the crusher device 26. The bypass chute 86 directs the feed of material into a desired location away from the crusher device 26 when the diverter chute 56 is in this second position shown in FIG. 3B. As can be understood in the comparison of FIGS. 3A and 3B, the movement of the diverter chute 56 from the first position shown in FIG. 3A to the second position shown in FIG. 3B will control whether the feed of aggregate material is received by the crusher device 26. As discussed above, the movement of the diverter chute 56 from the first position to the second position is controlled by the actuation of the chute actuator 78. In the embodiment illustrated, the chute actuator 78 is a hydraulic cylinder that includes an extendable and retractable cylinder rod 76 having an internal piston driven by a supply of hydraulic fluid. The supply of hydraulic fluid to the hydraulic cylinder controls the selective movement of the discharge chute 56. It should be understood that other types of actuators could be used as the chute actuator 78, such as but not limited to a drive motor, pulley system, screw actuator or other similar type of device that is able to move the diverter chute 56 as shown in FIGS. 3A and 3B.

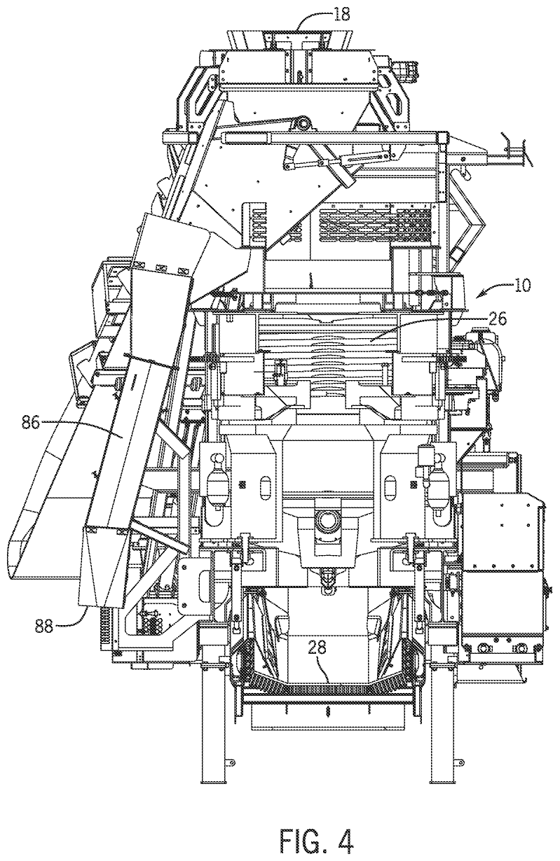

FIG. 4 provides an end view of the mobile crushing machine 10 and illustrates the position of the bypass chute 86 relative to the crusher device 26. As can be understood in FIG. 4, the crusher device 26 is generally located directly below the discharge end 18 of the feed conveyor while the bypass chute 86 is offset from the generally center, longitudinal axis of the feed conveyor. The material that is crushed by the crusher device 26 is received on the discharge conveyor 28 which is located directly below the crusher device 26. The discharge end 88 of the bypass chute 86, in turn, is laterally spaced from this discharge conveyor 28 such that the material that is passing through the bypass chute 86 is diverted away from both the crusher device 26 and the discharge conveyor 28.

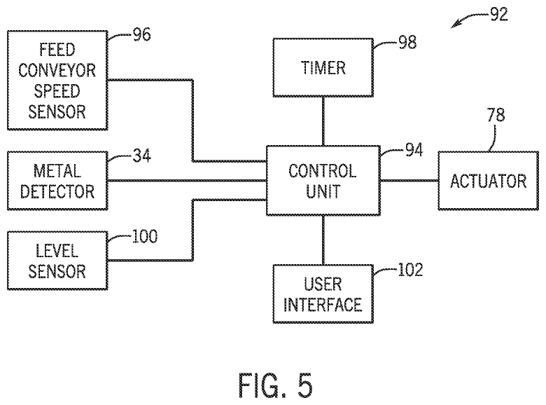

Referring now to FIG. 5, a schematic of the control components for determining and controlling the movement of the diverter chute 56 will now be described. As shown in FIG. 5, the control system 92 generally includes a control unit 94 that forms the main operating component of the control system 92. In the embodiment shown, the control unit 94 is a separate controller that is used to operate the diverter system of the present disclosure. However, it should be understood that the control unit 94 could be a part of the main operating controller used to control the entire operation of the mobile crushing machine 10 shown in FIG. 1. In one contemplated embodiment, the control unit 94 can be a separate controller that is separate from the control system for the entire mobile crushing machine. The separation of the control unit 94 from the main controller of the entire mobile crushing machine will allow the diverter system of the present disclosure to be retrofit onto an existing mobile crushing machine. In either embodiment, the control unit 94 controls the operation of the components in a manner as will be described below.

As described previously in FIGS. 1 and 2, a metal detector 34 is mounted at a location along the length of the moving conveyor belt of the feed conveyor 14. In the embodiment shown, the metal detector 34 is located above the moving conveyor belt although other locations are contemplated as long as the metal detector 34 is able to detect the presence of the undesirable and uncrushable metal material in the feed of the aggregate. The metal detector 34 is connected to a supply of electrical power and operates to detect the presence of metallic objects below the metal detector as the feed of aggregate material moves along the length of the feed conveyor from the infeed end to the discharge end. When the metal detector 34 detects the presence of a metallic material in the feed of aggregate, the metal detector generates a signal to the control unit 94 shown in FIG. 5. The signal generated by the metal detector 34 indicates the presence of metallic material within the sensing zone of the metal detector 34. The signal from the metal detector 34 will continue to be present until the metallic material is no longer detected beneath the metal detector 34. As stated above, the sensitivity of the metal detector can be adjusted or selected such that the metal detector is able to detect metal components that are large enough to either damage or jamb the operation of the crusher device.

Upon receiving the signal from the metal detector 34, the control unit is able to send an operating signal to the chute actuator 78. As discussed, and described previously in the discussion of FIGS. 3A and 3B, the chute actuator 78 is able to move the diverter chute 56 from a first mode in which the diverter chute 56 is in the first, normal operating position shown in FIG. 3A to the second mode in which the diverter chute 56 is in the second, diversion position shown in FIG. 3B. In the embodiment shown in FIG. 3B, the chute actuator 78 extends the cylinder rod 76 to move the diverter chute 56 to the second position shown in FIG. 3B. As long as the cylinder rod 76 is in this extended position, the diverter chute 56 will divert the continuous feed of aggregate material away from the crusher device.

In the embodiment shown, the feed conveyor 14 includes a feed conveyor speed sensor 96 that is able to determine the operating speed of the feed conveyor 14. Since the feed conveyor 14 has a known distance from the infeed end 16 to the discharge end 18, sensing the operating speed of the conveyor belt will allow the control unit 94 to calculate how long it will take for the aggregate material to travel along the length of the feed conveyor 15. Since the detector 34 is located at a known position of the feed conveyor and thus a known distance from the discharge end 18, the control unit 94 can determine the amount of time the sensed metallic material will travel along the feed conveyor 14 from the detector 34 to the discharge end 18. Thus, when the metal detector 34 detects the presence of a metallic material, the control unit 94 can determine the amount of time it will take for the metallic material to travel from the detector 34 to the discharge end 18. Based upon this known information, the control unit 94 can then delay the activation signal to the chute actuator 78 until the metallic material is about to reach the discharge end 18. In this manner, a minimum amount of aggregate material will be diverted away from the crusher device 26 to the bypass chute 86. It is desirable to discharge as little of the feed of the aggregate material away from the crusher device to avoid waste while still preventing the detected metallic material from entering into the crusher device.

The control unit 94 will maintain the chute actuator 78 in the diverting position to divert the feed of aggregate material away from the crusher device until the metal detector 34 no longer detects the presence of metallic material in the feed of the aggregate material. In accordance with the present disclosure, the control unit will utilize a timer 98 to create a specified timed delay after the sensing signal is no longer present from the metal detector 34. The specified, predetermined time delay ensures that the sensed metallic material is diverted away from the input to the crusher device before the control unit 94 causes the chute actuator 78 to return the diverter chute from the second position shown in FIG. 3B to the first position shown in FIG. 3A in which the feed of aggregate material is again fed to the crusher device 26.

Although a separate timer 98 is shown in the embodiment of the FIG. 5, it should be understood that the timer 98 could be incorporated directly into the control unit 94 while operating within the scope of the present disclosure. As described previously, since the control unit 94 knows the distance from the detector 34 to the discharge end 18 and also the speed of the conveyor based upon the speed sensor 96, the control unit 94 can assure that the feed of material is directed away from the crusher device 26 for only the minimum amount of time. As can be understood by the above description, the operating speed of the feed conveyor 14 is not stopper or interrupted upon detection of the metallic material by the metal detector 34. Instead, the feed conveyor 14 continues to operate at the operating speed or a modified operating speed and the control unit 94 controls the movement of the diverter chute 56 while the feed conveyor 14 continues to operate. In this manner, the feed conveyor does not need to be stopped or interrupted upon the detection of the metallic material by the metal detector 34. In another contemplated embodiment, the operating speed of the feed conveyor 14 could be reduced upon the detection of the metallic material until the metallic material has been cleared. Such embodiment would be practical in a system in which the feed conveyor is a hydraulically driven conveyor.

In the embodiment shown in FIG. 5, a user interface 102 is in communication with the control unit 94. The user interface 102 can be used to enter relevant information into the control unit 8=94, such as but not limited to the distance between the detector and the discharge end of the feed conveyor. In embodiments in which the control unit 94 is not connected to a speed sensor 96, the operating speed of the feed conveyor could also be supplied to the control unit 94 by the user interface 102.

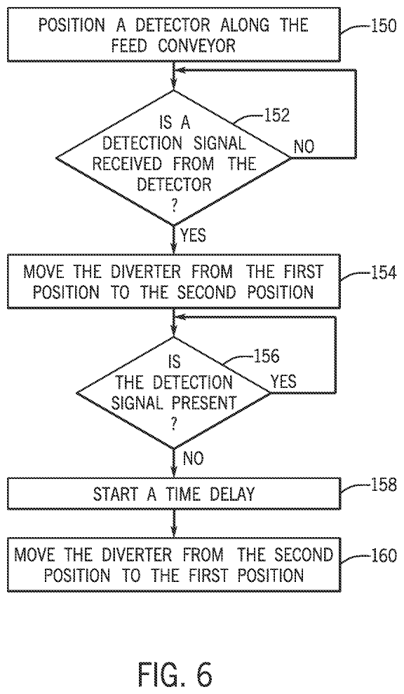

FIG. 6 generally illustrates one embodiment of a method for controlling the operation of the diverter to divert the feed of aggregate material away from the crusher device on the detection of an undesirable, metallic material. As shown in step 150, the detector is initially positioned at a location along the length of the feed conveyor such that the detector is able to detect the presence of an undesirable material in the feed of the aggregate material along the length of the feed conveyor 14. In the embodiment shown in FIGS. 1 and 2, the detector 34 is positioned at a distance from the discharge end and a distance above the moving surface of the conveyor belt of the feed conveyor such that the detector 34 can detect the presence of the undesirable material.

In step 152, the control unit of the system determines whether a detection signal is received from the detector 34. If no detection signal is received, the system continues to operate to feed the aggregate material to the crusher device such that the crusher device can continue to operate to reduce the size of the aggregate material. However, if the system determines in step 152 that a detection signal has been received, the system moves to step 154. In step 154, the system moves the diverter from the first mode, such as the first position shown in FIG. 3A, to the second mode, such as the second position shown in FIG. 3B. This movement can be delayed by the control unit for a small amount of time that is based upon the distance between the detector 34 and the discharge end 18 of the feed conveyor. This delay in movement of the diverter chute ensures that a minimum amount of aggregate material is diverted away from the crusher device.

In step 156 shown in FIG. 6, the system determines whether the detection signal remains present. If the detection signal remains present, the system continues to monitor the detector until the detection signal is no longer present. Whenever the detection signal is present, the diverter remains in the second position to divert the feed of aggregate material from the crusher device.

If the detection signal is no longer present, the system moves to step 158 and the delay timer is started. The delay timer is used to allow the detected material on the feed conveyor to pass over the discharge end 18 to ensure that the feed of aggregate material is not directed back to the crusher until all of the undesirable material has been diverted. Once the time delay has expired in step 158, the system moves to step 160 and the diverter is again returned from the second mode, such as the second, diverting position shown in FIG. 3B to the first mode, such as the first position shown in FIG. 3A. In this first position, the feed of aggregate material is again returned to the crusher device 26 for processing.

Referring back to FIG. 5, in accordance with another aspect of the present disclosure, a level sensor 100 can be included in the crusher device 26. The level sensor 100 will be positioned as close to the upper open entrance of the crusher device 26 as possible and will generate a signal when material begins to back up within the crusher device 26. Material will begin to back up within the crusher device 26 when undesirable material jams the operation of the crusher device or when the feed of aggregate material to the crusher device is faster than the crusher device 26 can handle.

Upon receiving the signal from the level sensor, the control unit 94 can actuate the chute actuator 78 to divert any additional feed of material away from the crusher device. In this manner, the control unit 94 can intermittently divert material flow away from the crusher device 26 to prevent overfeeding of the crusher device. Once the signal from the level sensor 100 is no longer present, the control unit 94 will again deactivate the chute actuator, thereby moving the diverter chute 56 to the first position shown in FIG. 3A.

As shown in FIG. 5, the user interface 102 can be connected to the control unit 94. The user interface 102 can be used to enter a wide variety of operating parameters into the control unit 94. As an illustrative example, the distance between the detector 34 and the discharge end 18 could be entered by an operator into the control unit 94 such that the control unit could determine the amount of time needed for material to travel from the detector 34 to the discharge end 18. Although a speed sensor 96 is shown in the embodiment of FIG. 5, the speed sensor 96 could be eliminated and the operating speed could be entered by a user utilizing the user interface 102.

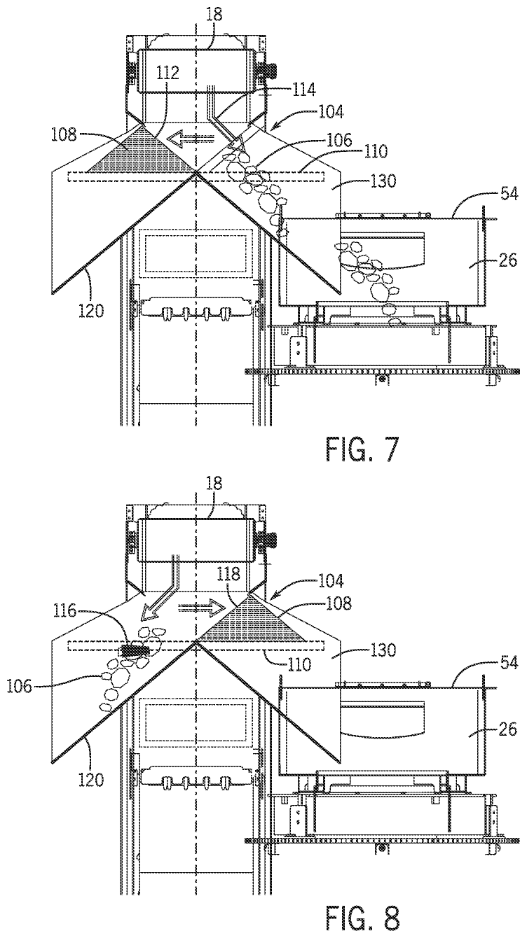

FIGS. 7 and 8 illustrate a first, alternate embodiment of a diverter 104 that is operable to divert the feed of aggregate material 106 to either the open entrance 54 of the crusher device 26 or to a bypass chute 120 such that the feed of aggregate is not crushed by the crusher device 26. The diverter 104 shown in the first alternate embodiment operates between a first mode shown in FIG. 7 in which the feed of aggregate 106 is directed to the crusher device 26 and a second mode shown in FIG. 8 in which the feed of aggregate 106 is directed away from the crusher device 26. The diverter 104 in the first alternate embodiment shown in FIGS. 7 and 8 includes a shelve-gate 108 that is movable between the first position shown in FIG. 7 and the second position shown in FIG. 8. The shelve-gate 108 is movable laterally along a support track 110 such that an actuator, such as a hydraulic ram, is able to move the shelve-gate 108 between the first position and the second position. When the shelve-gate 108 is in the first position shown in FIG. 7, the feed of aggregate 106 contacts the first side 112 of the shelve-gate 108 and is diverted toward the open entrance 54 of the crusher device 26, as shown by arrow 114. In this manner, the feed of aggregate leaving the discharge end 18 of the feed conveyor is directed toward the crusher device 26.

In the same manner as previously discussed, when the detector determines that an undesirable or uncrushable material 116 is present in the feed of aggregate 106, the control unit moves the shelve-gate 108 to the second position shown in FIG. 8. This movement is illustrated by arrow 117. In this second position, the feed of aggregate 106 contacts the sloping second surface 118 such that the feed of aggregate 106 is directed into the bypass chute 120. The bypass chute 120 directs the feed of aggregate 106 away from the crusher 26 in a similar manner as described previously with respect to the initial embodiment shown in the drawing figures. As can be understood in FIGS. 7 and 8, the slope of the walls that form the first and second sides 112, 118 of the shelve-gate 108 is greater than the slope of the upper wall of the bypass chute 120 and the feed chute 130 to prevent rock jamming. In this manner, the diverter 104 is able to divert the feed of aggregate leaving the feed conveyor at the discharge end 18 to either the crusher device 26 or to a diverted location in the same manner as previously described with respect to the initial embodiment in FIGS. 1-4.

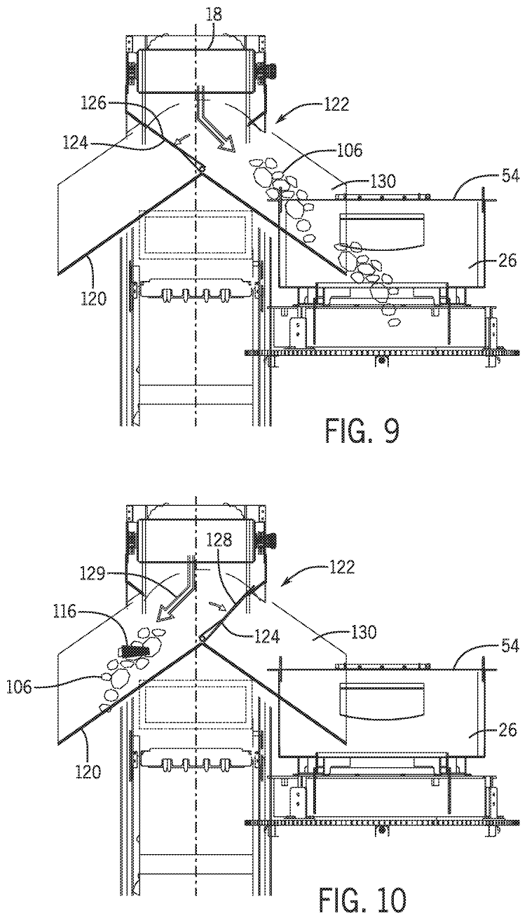

FIGS. 9-10 illustrate a second alternate embodiment of a diverter 122 contemplated as being part of the present disclosure. In the second alternate embodiment of FIGS. 9 and 10, the diverter 122 includes a swing-flap gate 124 that is movable between a first mode shown in FIG. 9 and a second mode shown in FIG. 10. When the diverter 122 is in the first mode, the feed of aggregate 106 is directed by the feed chute 130 to the open entrance 54 of the crusher device 26. When the swing-flap gate 124 is in the second mode shown in FIG. 10, the feed of aggregate 106, which includes the uncrushable material 116, is directed to the discharge chute 120. As in the other embodiments previously described, when the detector and the control unit detect the presence of the undesirable or uncrushable material 116, the diverter 122 is moved from the first mode shown in FIG. 9 to the second mode shown in FIG. 10 to prevent the feed of aggregate from entering into the crusher device 26.

As shown in FIG. 9, when the swing-flap gate 124 is in the first position, the feed of aggregate 106 contacts the first surface 126 such that the feed of aggregate 106 is directed into the feed chute 130 and toward the open entrance 54 of the crusher device 26. In this position, the swing-flap gate 124 blocks access to the bypass chute 120. It is contemplated that the swing-flap gate 124 would remain in this first position shown in FIG. 9 during normal operation of the mobile crushing machine. In this manner, the feed of aggregate leaving the discharge end 18 of the feed conveyor will be directed to the crusher device 26 for processing.

If the detector and control unit detect the presence of the undesirable or uncrushable material 116 in the feed of aggregate 106, the control unit is able to move the swing-flap gate 124 from the first position shown in FIG. 9 to the second position shown in FIG. 10. The diverter 122 includes a hydraulic ram that acts as the actuator to move the swing-flap gate 124 to the second position shown in FIG. 10. When the swing-flap gate 124 is in the second position, the feed of aggregate 106 contacts the second surface 128 and is directed into the discharge chute 120 as shown by arrow 129. In this position, the swing-flap gate 124 blocks access to the feed chute 130. As described in the previous embodiments, the swing-flap gate 124 will remain in the second position until the control unit determines that the uncrushable material 116 has cleared the discharge area and a time period has expired. Upon this determination, the control unit moves the swing-flap gate 124 back to the first position shown in FIG. 9 such that the aggregate feed 106 is again directed toward the crusher device 26. In this manner, the diverter 122 shown in the second alternate embodiment functions in a similar manner as the diverter shown in the embodiment of FIGS. 1-4.

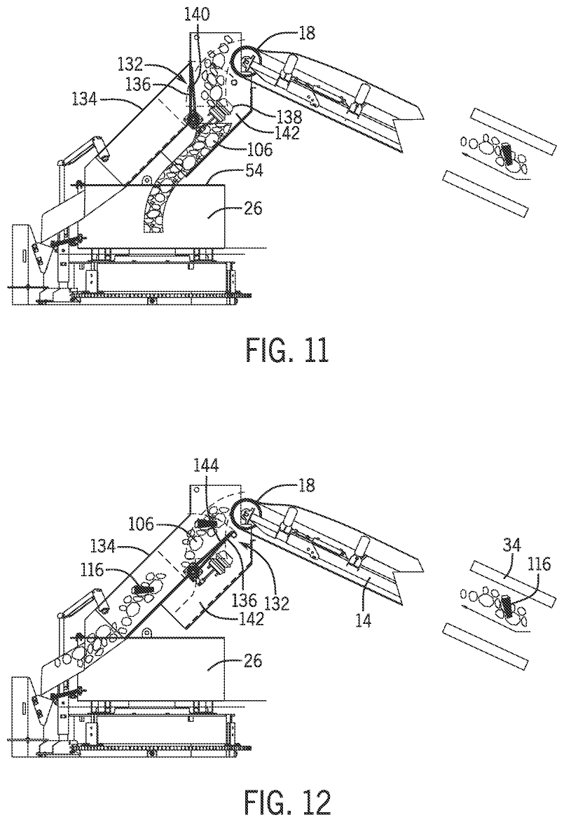

As can be understood in the first and second alternate embodiment shown in FIGS. 7-10, the bypass chute 120 and the feed chute 130 are oriented such that the feed of aggregate 106 is directed 90° in either direction relative to the direction of the feed of aggregate on the feed conveyor. In the third alternate embodiment shown in FIGS. 11 and 12, the feed of aggregate to the crusher device 26 is in line with the feed conveyor 14. In the third alternate embodiment shown in FIGS. 11 and 12, a diverter 132 is located in a position to selectively divert the feed of aggregate 106 to either the crusher device 26 or to a bypass chute 134. When the diverter 132 is in the first mode of operation as shown in FIG. 11, the feed of aggregate 106 is directed to the open entrance 54 of the crusher device 26. When the diverter 132 is in the second mode, the diverter 132 diverts the feed of aggregate 106 into the bypass chute 134 and away from the crusher device 26. As in the previous embodiments, when the detector and control unit sense the presence of the uncrushable material 116, the diverter 132 is moved to the second mode shown in FIG. 12 to prevent the uncrushable material 116 from entering into the crusher device 26.

In the embodiment shown in FIGS. 11 and 12, the diverter 132 includes a swing-flop gate 136 that is controlled by the operation of an actuator including an air chamber 138 having a hydraulic ram that is able to control the pivoting movement of the swing-flop gate 136. When the diverter 132 is in the first mode, the swing-flop gate 136 is in the first position shown in FIG. 11. In this first position, the swing-flop gate 136 blocks access to the bypass chute 134 such that the feed of aggregate 106 contacts the first surface 140. In this first position, the swing-flap gate 136 thus directs the entire feed of aggregate 106 into the crusher 26.

When the detector 34 detects the presence of the uncrushable material 116 in the feed of aggregate, the control unit moves the swing-flop gate 136 into the second position shown in FIG. 12. In this second position, the swing-flop gate 136 blocks the entrance to the feed chute 142 such that the entire feed of aggregate 106 contacts the second surface 144 such that the feed of aggregate 106 is directed into the bypass chute 134. As can be understood in the embodiment of FIGS. 11 and 12, the feed chute 142 and the bypass chute 134 are in line with each other and in line with the infeed conveyor 14. This alternate orientation of the feed and bypass chutes as compared to the embodiments shown in FIGS. 7-10 provides yet another alternate method and orientation to discharge the feed of aggregate 106 away from the crusher device 26 upon the detection of the uncrushable material 116.

As in the first embodiment described in FIGS. 1-4, the detector 34 is located at a known distance away from the discharge end 18 of the feed conveyor 14. The distance between the detector 34 and the discharge end 18 allows the control unit to selectively move the diverter from the first mode shown in FIG. 11 in which the feed of aggregate 106 is directed to the crusher device 26 to the second mode shown in FIG. 12 in which the feed of aggregate 106 is directed away from the crusher device 26 to prevent the uncrushable material 116 from entering into the crusher device 26.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A crushing machine for processing a feed of aggregate material, the crushing machine comprising:
a feed conveyor extending between an infeed end and a discharge end, the feed conveyor being positioned to receive the feed of aggregate at the infeed end and operable to move the feed of aggregate to the discharge end;
a crusher device positioned to receive the feed of aggregate and operable to reduce the size of the aggregate material;
a diverter positioned at the discharge end of the feed conveyor, the diverter being operable in a first mode to direct the feed of aggregate material to the crusher device and a second mode to direct the feed of aggregate material to a bypass location;
a detector operable to detect the presence of an undesirable material in the feed of aggregate material; and
a control unit operable to move the diverter chute to the second mode upon the detection of the undesirable material while the feed conveyor is operating to move the feed of aggregate material from the infeed end to the discharge end.

2. The crushing machine of claim 1 further comprising a bypass chute positioned to selectively receive the feed of aggregate from the feed conveyor when the diverter chute is in the second mode.

3. The crushing machine of claim 1 wherein the control unit moves the diverter chute to the second mode for a determined time period after the detector no longer detects the presence of the undesirable material.

4. The crushing machine of claim 1 wherein the feed conveyor operates at an operating speed and the feed conveyor does not deviate from the operating speed as the diverter chute is moved between the first and second modes.

5. The crushing machine of claim 1 wherein the detector is a metal detector that is located at a position along the length of the feed conveyor and is operable to detect the presence of a metallic material in the feed of aggregate material.

6. The crushing machine of claim 1 wherein the crusher device is a cone or gyratory crusher.

7. The crushing machine of claim 1 wherein the diverter is a diverter chute movable between a first position in the first mode and a second position in a second mode, further comprising a chute actuator coupled to the diverter chute, wherein the chute actuator is operable to move the diverter chute between the first and second positions.

8. The crushing machine of claim 7 wherein the control unit is operable to control the actuation of the chute actuator.

9. The crushing machine of claim 7 wherein the diverter chute is aligned with a longitudinal axis of the feed conveyor in the first position and positioned at an angle relative to the longitudinal axis is in the second position.

10. The crushing machine of claim 9 wherein the bypass chute is spaced laterally from the longitudinal axis of the feed conveyor.

11. A system for protecting a crusher device from receiving undesirable material included in a feed of aggregate material being fed to the crushing device by a feed conveyor that includes a moving conveyor belt extending from an infeed end to a discharge end, the system comprising:
a diverter positionable at the discharge end of the feed conveyor, the diverter chute being movable between a first mode to direct the feed of aggregate material to the crusher device and a second mode to direct the feed of aggregate material to a bypass location;
a detector positionable at a location along a length of the feed conveyor and operable to detect the presence of the undesirable material in the feed of aggregate material; and
a control unit operable to move the diverter to the second mode upon the detection of the undesirable material and while the feed conveyor is operating to move the feed of aggregate material from the infeed end to the discharge end.

12. The system of claim 11 further comprising a bypass chute positioned to selectively receive the feed of aggregate from the feed conveyor when the diverter chute is in the second mode.

13. The system of claim 11 wherein the control unit moves the diverter to the second mode for a determined time period after the detector no longer detects the presence of the undesirable material.

14. The system of claim 11 wherein the detector is a metal detector that is operable to detect the presence of a metallic material in the feed of aggregate material.

15. The system of claim 11 wherein the diverter is a diverter chute movable between a first position in the first mode and a second position in a second mode, further comprising a chute actuator coupled to the diverter chute, wherein the chute actuator is operable to move the diverter chute between the first and second positions.

16. The system of claim 15 wherein the diverter chute is aligned with a longitudinal axis of the feed conveyor in the first position and positioned at an angle relative to the longitudinal axis is in the second position.

17. A method of protecting a crusher device from receiving undesirable material included in a feed of aggregate material being fed to the crushing device by a feed conveyor that includes a moving conveyor belt extending from an infeed end to a discharge end, the method comprising the steps of:
positioning a diverter at the discharge end of the feed conveyor, the diverter being movable between a first mode to direct the feed of aggregate material to the crusher device and a second mode to direct the feed of aggregate material to a bypass location;
detecting the presence of the presence of the undesirable material in the feed of aggregate material; and
moving the diverter from the first mode to the second mode upon the detection of the undesirable material.

18. The method of claim 17 wherein the feed conveyor is operated at an operating speed and the diverter is moved between the first and second modes while the feed conveyor is operated at the operating speed.

19. The method of claim 18 wherein the diverter is moved back from the second mode to the first mode after the undesirable material is no longer detected and after a specific time delay.

20. The method of claim 17 further comprising the step of moving the diverter from the first mode to the second mode upon detection of a level of material in the crusher device that exceeds a maximum level of material.
